(19) United States
(12) Patent Application Publication
(10) Pub. No.: US 2026/0066162 A1
(43) Pub. Date: Mar. 5, 2026

(54) MULTI-LAYER COIL STRUCTURE, INDUCTOR, AND METHOD FOR MANUFACTURING MULTILAYER COIL STRUCTURE

(71) Applicant: InMicro Integrated Magnetic Technology Co., Ltd., Xiamen (CN)

(72) Inventors: Fujian DING, Xiamen (CN); Shiwei CHEN, Xiamen (CN); Siyuan SUN, Xiamen (CN)

(21) Appl. No.: 18/969,356

(22) Filed: Dec. 5, 2024

(30) Foreign Application Priority Data
Sep. 3, 2024 (CN) 202411227986.6

(51) Int. Cl. H01F 5/00; H01F 5/04; H01F 5/06; H01F 41/04; H01F 41/12; H01F 41/22

(52) U.S. Cl. CPC H01F 5/003; H01F 5/04; H01F 5/06; H01F 41/041; H01F 41/12; H01F 41/22

(57) ABSTRACT

The present disclosure provides a multi-layer coil structure, an inductor, and a method for manufacturing the multi-layer coil structure. The multi-layer coil structure includes subcoils arranged in a stacked manner, where each subcoil includes a bottom coil, an insulating film, and a top coil, a contact is arranged in a through hole of the insulating film, outer surfaces of the bottom coil and the top coil are both provided with an insulating layer, and the insulating layer is provided with a via hole; via holes in adjacent subcoils are aligned with each other, and metal contacts are arranged in the via holes. The problem of insulation in a multi-layer multi-turn coil is solved.

### CROSS-REFERENCE TO RELATED APPLICATIONS

This application claims priority to Chinese Patent Application 202411227986.6, filed on Sep. 3, 2024, which is incorporated herein by reference.

### TECHNICAL FIELD

The present disclosure relates to the field of manufacturing electronic components, and in particular, to a multi-layer coil structure, an inductor, and a method for manufacturing the multi-layer coil structure.

### BACKGROUND

In a semiconductor manufacturing process, coils, as a key component, are widely applied to various process steps, such as photoetching, etching, and ion implantation, and the performance thereof directly affects the process precision and the yield. Traditional semiconductor machining coil designs are mainly limited to double-layer multi-turn or multi-layer single-turn structures. The multi-layer single-turn structure: in such a design, single-turn double-layer coils are formed by etching a multi-layer conductive film on two sides of an insulating film, and the several single-turn double-layer coils are stacked and welded to form the multi-layer single-turn structure, as shown in FIG. 1. The double-layer multi-turn structure: as shown in FIG. 2, multi-turn coils are formed by etching a multi-layer film on two sides of an insulating film respectively, however, due to the depth-to-width ratio of etching, the double-layer multi-turn coil cannot be high enough. Although this design meets basic process requirements to some extent, with the continuous development of semiconductor technology, higher requirements are imposed on the accuracy, stability and reliability of the coils.

Manufacturing the multi-layer multi-turn coil faces significant challenges in terms of insulation. Interlayer insulation becomes an insurmountable technical obstacle due to the fact that the number of coil layers is increased and the layers need to be closely arranged to implement efficient electromagnetic conversion. The selection of an insulation material, the thickness of an insulation layer and the optimized design of an interlayer insulation structure are all key factors affecting the performance of the coils. If the insulation is insufficient, an interlayer short circuit will likely be caused, thereby causing a device fault or even a security accident; and if the insulation is too thick, the electromagnetic performance and heat dissipation efficiency of the coils will be affected, thereby reducing the overall process effect.

Therefore, there is a need for a method for manufacturing a multi-layer multi-turn coil structure, which can effectively solve the problem of multi-layer multi-turn insulation while ensuring efficient electromagnetic conversion, thereby improving the accuracy, stability and reliability of the coils, to adapt to rapid development of semiconductor manufacturing technologies.

### SUMMARY

In order to solve the above problems, the objectives of the present disclosure are to provide a multi-layer coil structure, an inductor, and a method for manufacturing the multi-layer coil structure, where double-sided subcoils are subjected to insulation processing, and aligned via holes are formed between adjacent subcoils and filled with a conductive material, so that the adjacent subcoils are in communication with each other, thereby solving the problem of insulation in a multi-layer multi-turn structure, and implementing the number of coil turns achievable under the same product height exceeding that of traditional processes.

The present disclosure is implemented by the following technical solutions:

A multi-layer coil structure includes:
at least two subcoils arranged in a stacked manner, wherein each subcoil includes a bottom coil, an insulating film arranged on the bottom coil, and a top coil arranged on the insulating film, the insulating film includes at least one through hole, and a contact is arranged in the through hole, so that the bottom coil and the top coil located on two sides of the insulating film are in electrical contact with each other; and outer surfaces of the bottom coil and the top coil are both provided with an insulating layer, and the insulating layer is provided with a via hole;
via holes in adjacent subcoils are aligned with each other, and metal contacts are arranged in the via holes, so that the adjacent subcoils are in electrical contact with each other; and
the through hole and the via hole in a same subcoil are arranged in a staggered manner.

Further, a total width of each subcoil is consistent.

Further, a via hole in the subcoil located at a bottom layer corresponds to a tail end of a top coil thereof, and a via hole in the subcoil located at a top layer corresponds to a head end of a bottom coil thereof; and via holes in the subcoils located in a middle correspond to head ends of bottom coils and tail ends of top coils, respectively.

A method for manufacturing a multi-layer coil structure includes the following steps:
S1, preparing at least two full-board double-sided coils, each full-board double-sided coil including several subcoils arranged in an array, and each subcoil being a double-sided coil;
S2, subjecting each full-board double-sided coil to insulation processing, so that an outer surface of each double-sided coil is coated with an insulating layer;
S3, forming via holes for coils to be in communication with outside by removing an insulating layer corresponding to a head end of each bottom coil of a full-board double-sided coil located at a top layer, removing an insulating layer corresponding to a tail end of each top coil of a full-board double-sided coil located at a bottom layer, and removing insulating layers corresponding to head ends of bottom coils and tail ends of top coils of full-board double-sided coils located in a middle;
S4, filling via holes in top coils with a conductive material, a height of the conductive material being greater than twice that of a peripheral insulating layer thereof;
S5, stacking and attaching several full-board double-sided coils subjected to processing in S2, S3 and S4, and aligning via holes in two adjacent full-board double-sided coils on a one-to-one basis;
S6, heating, so that insulating layers of adjacent full-board double-sided coils are adhered and fixed; and
S7, cutting to obtain single coils formed by stacking the several subcoils.

Further, a method for preparing the full-board double-sided coils in S1 includes:
laying a first conductive metal;
etching the first conductive metal to form several bottom coil patterns;
laying an insulating film on the first conductive metal, the insulating film being provided with a through hole, and the through hole corresponding to a tail end of a bottom coil on a one-to-one basis;
arranging a contact in the through hole, an upper end surface of the contact protruding from an upper surface of the insulating film;
laying a second conductive metal on the insulating film; and
etching the second conductive metal to form several top coil patterns, top coils being in contact with the contact.

Further, a method for subjecting each double-sided coil to insulation processing in S2 includes: vacuum-plating the double-sided coil, so that the outer surface of the double-sided coil is coated with an insulating layer.

Further, the insulating layer is made of Parylene.

Further, the insulating layer is made of silicon dioxide.

Further, a method for subjecting each double-sided coil to insulation processing in S2 includes: coating the outer surface of the double-sided coil with an insulating layer by using a dispensing process.

Further, the insulating layer is made of epoxy resin.

Further, the insulating layer is made of a UV curing adhesive.

Further, in S2, after subjecting the double-sided coil to insulation processing and before forming the via holes, the method further includes recognizing the double-sided coil for detection.

Further, a method for subjecting each double-sided coil to insulation processing in S2 includes: coating the outer surface of the double-sided coil with an insulating layer by using a printing process.

Compared with the prior art, the technical solutions of the present disclosure have the following beneficial effects:
(1) According to the multi-layer coil structure of the present disclosure, the outer surfaces of the subcoils are subjected to insulation processing, and the aligned via holes are formed between the adjacent subcoils and filled with the conductive material, so that the adjacent subcoils are in communication with each other. The problem of insulation in a multi-layer multi-turn structure is solved, and the number of coil turns achievable under the same product height exceeds that of traditional processes.
(2) According to the method for manufacturing the multi-layer coil structure of the present disclosure, the full-board double-sided coils are subjected to insulation processing, and the aligned via holes are formed between the adjacent subcoils and filled with the conductive material, so that the adjacent subcoils are in communication with each other. More coils are included in the formed multi-layer coil structure by consuming the same number of subcoils. Meanwhile, more layers are formed in the product in the same volume, i.e., more turns are achieved.
(3) According to the method for manufacturing the multi-layer coil structure of the present disclosure, the number of turns of the bottom coil and the top coil of each subcoil can be designed freely, so that products with different inductance values are formed, thereby being flexible and having a wide range of application.

### BRIEF DESCRIPTION OF DRAWINGS

FIG. 1 is a sectional view of a multi-layer single-turn coil structure in the prior art provided by the present disclosure;

FIG. 2 is a sectional view of a double-layer multi-turn coil structure in the prior art provided by the present disclosure;

FIG. 3 is a sectional view of a multi-layer multi-turn coil structure provided by an embodiment of the present disclosure;

FIG. 4 is a schematic view I of manufacturing steps of the multi-layer multi-turn coil structure provided by an embodiment of the present invention;

FIG. 5 is a schematic view II of manufacturing steps of the multi-layer multi-turn coil structure provided by an embodiment of the present invention;

FIG. 6 is a schematic view III of manufacturing steps of the multi-layer multi-turn coil structure provided by an embodiment of the present invention;

FIG. 7 is a schematic view IV of manufacturing steps of the multi-layer multi-turn coil structure provided by an embodiment of the present invention;

FIG. 8 is a schematic view V of manufacturing steps of the multi-layer multi-turn coil structure provided by an embodiment of the present invention.

FIG. 9a is a schematic structural view I of a first subcoil in a multi-layer single-turn coil provided by an embodiment of the present invention;

FIG. 9b is a schematic structural view II of the first subcoil in the multi-layer single-turn coil provided by an embodiment of the present invention;

FIG. 10a is a schematic structural view I of a second subcoil in the multi-layer single-turn coil provided by an embodiment of the present invention;

FIG. 10b is a schematic structural view II of the second subcoil in the multi-layer single-turn coil provided by an embodiment of the present invention;

FIG. 11a is a schematic structural view I of a third subcoil in the multi-layer single-turn coil provided by an embodiment of the present invention;

FIG. 11b is a schematic structural view II of the third subcoil in the multi-layer single-turn coil provided by an embodiment of the present invention;

FIG. 12a is a schematic structural view I of a first subcoil in a multi-layer multi-turn coil provided by an embodiment of the present invention;

FIG. 12b is a schematic structural view II of the first subcoil in the multi-layer multi-turn coil provided by an embodiment of the present invention;

FIG. 13a is a schematic structural view I of a second subcoil in the multi-layer multi-turn coil provided by an embodiment of the present invention;

FIG. 13b is a schematic structural view II of the second subcoil in the multi-layer multi-turn coil provided by an embodiment of the present invention;

FIG. 14a is a schematic structural view I of a third subcoil in the multi-layer multi-turn coil provided by an embodiment of the present invention;

FIG. 14b is a schematic structural view II of the third subcoil in the multi-layer multi-turn coil provided by an embodiment of the present invention;

FIG. 15a is a schematic view I of a certain double-layer multi-turn coil structure provided by an embodiment of the present invention;

FIG. 15b is a schematic view II of a certain double-layer multi-turn coil structure provided by an embodiment of the present invention;

FIG. 16 is a schematic view of preparation in S11 to S16 provided by an embodiment of the present invention.

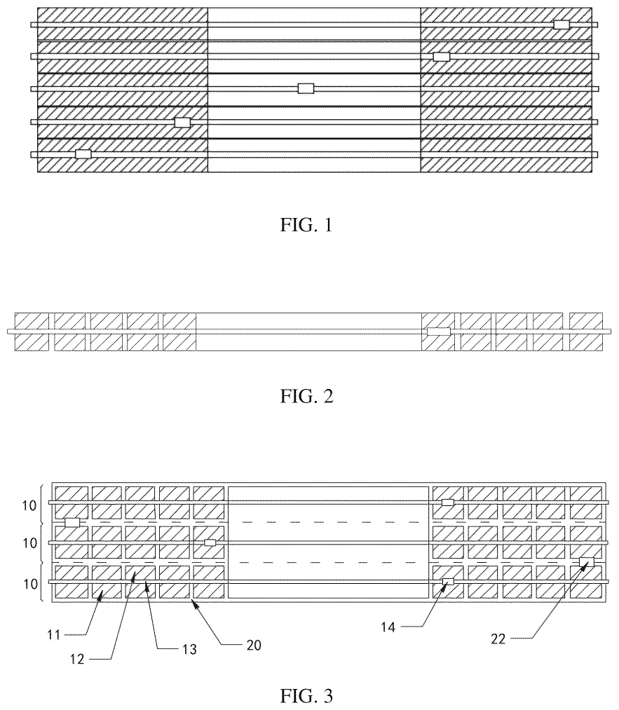

### NOTES

Subcoil—10; Bottom coil—11; Top coil—12; Insulating film—13; Contact—14; Through hole—15; Insulating layer—20; Via hole—21; Metal contact—22; First conductive metal—111; Second conductive metal—121;

First subcoil—100, 400; First contact—101, 401; First via hole—102, 402; First electrode end—130 , 430;

Second subcoil—200, 500; Second contact—201, 501; Second via hole—202, 502; Third electrode hole—203, 503;

Third subcoil—300, 600; Third contact—301, 601; Fourth via hole—302, 602; Second electrode end—330, 630.

### DESCRIPTION OF EMBODIMENTS

To make the objectives, technical solutions, and advantages of the embodiments of the present disclosure clearer, the following will clearly and completely describe the technical solutions in the embodiments of the present disclosure in conjunction with the drawings in the embodiments of the present disclosure. Apparently, the embodiments to be described are merely a part rather than all of the embodiments of the present disclosure. It should be understood that the embodiments described herein are only intended to explain the present disclosure, but not to limit the present disclosure. All other embodiments obtained by persons of ordinary skill in the art based on the embodiments of the present disclosure without creative efforts shall fall within the scope of protection of the present disclosure.

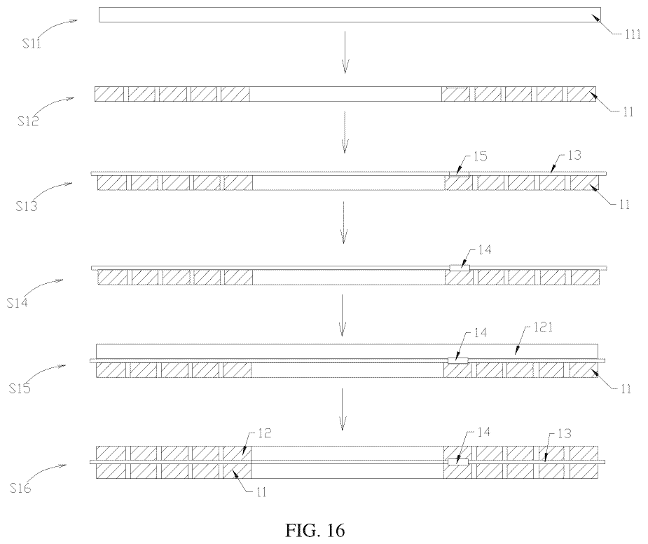

Referring to FIG. 3, a multi-layer coil structure includes at least two subcoils 10 arranged in a stacked manner, and each subcoil 10 includes a bottom coil 11, an insulating film 13 arranged on the bottom coil 11, and a top coil 12 arranged on the insulating film 13. Here, the bottom coil 11 and the top coil 12 are formed by etching a conductive metal or a plurality of stacked conductive metals, to obtain a desired pattern. The insulating film includes at least one through hole 15 (as shown in FIG. 16), a contact 14 is arranged in the through hole, and through the contact 14, the bottom coil 11 and the top coil 12 located on two sides of the insulating film 13 are in electrical contact with each other.

Outer surfaces of the bottom coil 11 and the top coil 12 are both provided with an insulating layer 20, the insulating layer 20 is provided with a via hole 21 (as shown in FIG. 6), via holes 21 in adjacent subcoils 10 are aligned with each other, and metal contacts 22 are arranged in the via holes 21, so that the adjacent subcoils 10 are in electrical contact with each other. It can be understood that the through hole 15 and the via hole 21 in a same subcoil 10 are arranged in a staggered manner, thereby avoiding a short circuit of a conductive coil.

In this embodiment, a total width of each subcoil 10 is consistent, so that the stability of the multi-layer coil structure is better, and the total width refers to a width from an inner side to an outer side of a single-sided coil. Via holes 21 correspond to head ends of bottom coils 11 and tail ends of top coils 12, respectively, so that the current flow path is longer.

During working: a current flowing in the head end (electrode end) of the bottom coil 11 of the subcoil 10 at a bottom layer can flow into the head end of the top coil 12 from the tail end of the bottom coil 11 via the contact 14, to finally flow out from the tail end of the top coil 12, and flow into the head end of the bottom coil 11 of the next subcoil 10 after passing through the metal contact 22, in this way until flowing out from the tail end (electrode end) of the top coil 12 of the subcoil 10 at a top layer.

This embodiment further provides a method for manufacturing a multi-layer multi-turn coil structure, including the following steps:

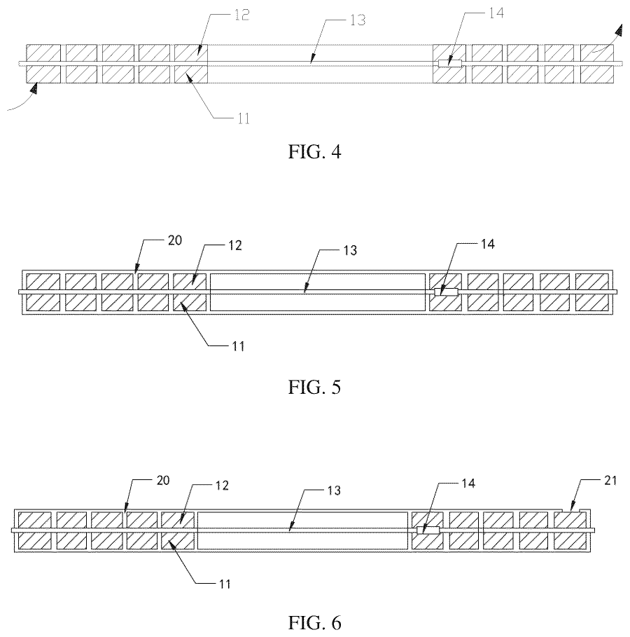

S1, preparing at least two full-board double-sided coils, each full-board double-sided coil including several subcoils 10 arranged in an array, and each subcoil 10 being a double-sided coil. In order to facilitate clear signs, FIG. 4 and subsequent drawings only show the structure of the subcoil 10 or the single coil. As shown in FIG. 4, a current flows in from the head end of the bottom coil 11, flows through patterns of the bottom coil 11, flows from the tail end of the bottom coil 11 to the head end of the top coil 12 via the contact 14, and finally flows out from the tail end of the top coil 12, as indicated by the arrows.

As shown in FIG. 16, a method for producing the double-sided coils includes:
S11, laying a first conductive metal 111;
S12, etching the first conductive metal 111 to form several bottom coil 11 patterns. In this embodiment, the number of coil turns≥1. It should be noted that the number of coil turns is not limited to a full turn (an integer turn), and may be four-fifths, five-sixths, and so on, thereby refining the precision of the number of coil turns, better matching a desired design inductance value, covering the inductance values of all products on a market, and having a wide range of application.
S13, laying an insulating film 13 on the first conductive metal 111 (the bottom coil 11 has now been prepared), the insulating film 13 being provided with a through hole 15, and the through hole 15 corresponding to a tail end of a bottom coil 11 on a one-to-one basis.
S14, arranging a contact 14 in the through hole, an upper end surface of the contact 14 protruding from an upper surface of the insulating film 13.
S15, laying a second conductive metal 121 on the insulating film 13.
S16, etching the second conductive metal 121 to form several top coil 12 patterns, head ends of top coils 12 corresponding to through holes 15 on a one-to-one basis. Similarly, the number of turns of the top coil 12 may also be a non-integer number. The top coil 12 is in contact with the contact 14, so that a full-board material including several double-sided coils is obtained. Within the same full-board, each bottom coil 11 has the same pattern, and each top coil 12 has the same pattern.
S2, subjecting each full-board double-sided coil to insulation processing, so that an outer surface of each full-board double-sided coil is coated with an insulating layer 20. As shown in FIG. 5, the outer surface of the double-sided coil includes top surfaces and side surfaces of the bottom coil 11 and the top coil 12, thereby realizing the insulation between multi-turn coils.

A method for coating the double-sided coils with insulating layers 20 includes: vacuum-plating the double-sided coil, so that the outer surface of the double-sided coil is coated with an insulating layer 20, the insulating layer 20 being made of Parylene or silicon dioxide. Alternatively, the outer surface of the double-sided coil is coated with an insulating layer 20 by using a printing process, the insulating layer 20 being made of epoxy resin or a UV curing adhesive. Alternatively, the outer surface of the double-sided coil is coated with an insulating layer 20 by using a dispensing process, the insulating layer 20 being made of epoxy resin or a UV curing adhesive.

S21, recognizing the full-board double-sided coil subjected to insulation processing to detect whether the outer surface of the coil is completely covered with the insulating layer 20.

S3, forming via holes 21, as shown in FIG. 6. Specifically, via holes 21 for coils to be in communication with outside are formed by removing an insulating layer 20 corresponding to a head end of each bottom coil 11 of a full-board double-sided coil located at a top layer, removing an insulating layer 20 corresponding to a tail end of each top coil 12 of a full-board double-sided coil located at a bottom layer, and removing insulating layers 20 corresponding to head ends of bottom coils 11 and tail ends of top coils 12 of full-board double-sided coils located in a middle.

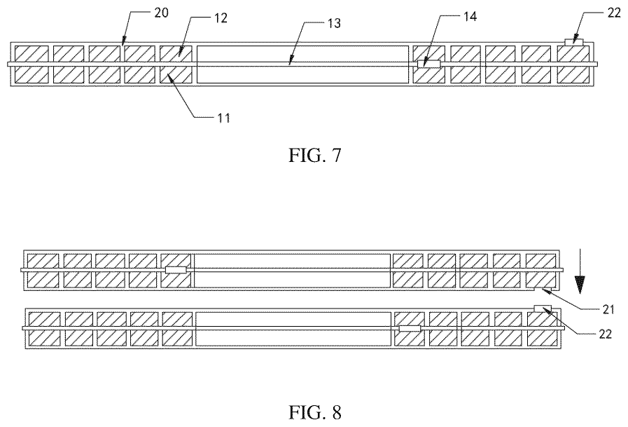

S4, filling via holes 21 in top coils 12 with a conductive material, e.g., a metal contact 22, as shown in FIG. 7. The height of the conductive material is greater than twice that of a peripheral insulating layer 20 thereof, so that the conductive material can pass through the two aligned via holes 21.

S5, stacking and attaching several double-sided coils subjected to processing in S2, S3 and S4, and aligning via holes 21 in two adjacent double-sided coils, as shown in FIG. 8, where the two adjacent double-sided coils are in communication with each other through the metal contact 22 arranged in the via hole 21.

S6, heating, so that insulating layers 20 of adjacent double-sided coils are adhered and fixed, thereby forming the multi-layer multi-turn coil structure, as shown in FIG. 3.

S7, cutting to obtain a single coil formed by stacking several subcoils 10, a tail end of a top coil 12 of a subcoil 10 at a top layer and a head end of a bottom coil 11 of a subcoil 10 at a bottom layer being two electrode ends of the single coil respectively.

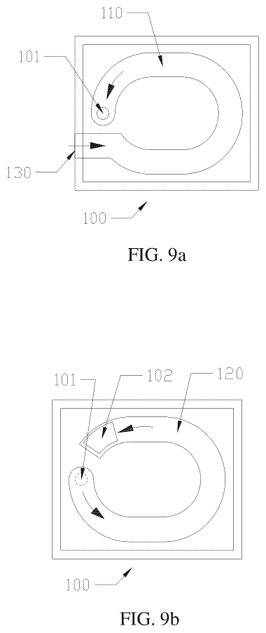

Referring to FIG. 9a to FIG. 11b, the multi-layer coil structure of the present application will be described below by taking each subcoil being double-layer single-turn as an example.

In FIG. 9a and FIG. 9b, a structure of a first subcoil 100 is shown, FIG. 9a is a top view from the bottom coil 110 direction, and FIG. 9b is a top view from the top coil 120 direction. A head end of a bottom coil 110 of the first subcoil 100 is a first electrode end 130, and a through hole is formed in an insulating film corresponding to a tail end of the bottom coil 110 and is provided with a first contact 101. A current flows from the first electrode end 130 to the tail end of the bottom coil 110 of the first subcoil 100, then flows to a head end of a top coil 120 of the first subcoil 100 via the first contact 101, and finally is led out from a conductive material arranged in a first via hole 102 in a tail end of the top coil 120.

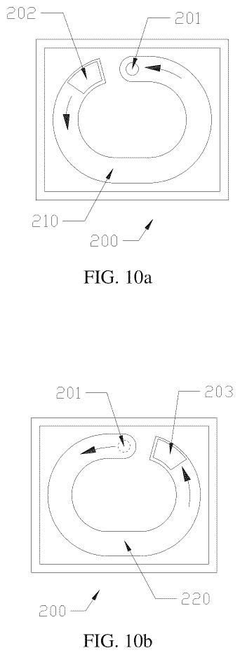

In FIG. 10a and FIG. 10b, a structure of a second subcoil 200 is shown, FIG. 10a is a top view from the bottom coil 210 direction, and FIG. 10b is a top view from the top coil 220 direction. A second via hole 202 is formed in an insulating layer corresponding to a head end of a bottom coil 210 of the second subcoil 200, and the second via hole 202 is aligned with the first via hole 102.

The head end of the bottom coil 210 is in communication with the tail end of the top coil 120 via the conductive material arranged in the first via hole 102, and a current flows from the conductive material in the first via hole 102 to the head end of the bottom coil 210, then to a tail end of the bottom coil 210, is conducted to a head end of a top coil 220 of the second subcoil 200 via a second contact 201 arranged at the tail end of the bottom coil 210, and finally is led out from a conductive material arranged in a third via hole 203 in a tail end of the top coil 220.

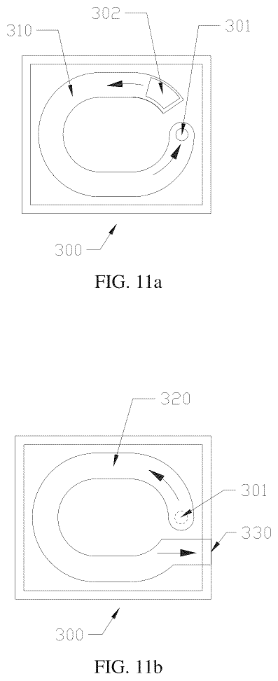

In FIG. 11a and FIG. 11b, a structure of a third subcoil 300 is shown, FIG. 11a is a top view from the bottom coil 310 direction, and FIG. 11b is a top view from the top coil 320 direction. A fourth via hole 302 is formed in an insulating layer corresponding to a head end of a bottom coil 310 of the third subcoil 300, and the fourth via hole 302 is aligned with the third via hole 203.

The head end of the bottom coil 310 of the third subcoil 300 is in communication with the tail end of the top coil 220 of the second subcoil 200 via the conductive material arranged in the third via hole 203, and a current flows from the conductive material in the third via hole 203 to the head end of the bottom coil 310, then to a tail end of the bottom coil 310, is conducted to a head end of a top coil 320 of the third subcoil 300 via a third contact 301 arranged at the tail end of the bottom coil 310, and finally flows out from a tail end, i.e., a second electrode end 330, of the top coil 320.

It can be understood that the second subcoil 200 may be several in number and is not limited to one in the examples, and can be adjusted and designed on its own as required. In the traditional method for manufacturing a single-turn multi-layer coil, three double-layer single-turn subcoils can form a four-layer single-turn coil structure (a top coil 120 of a first subcoil 100 and a bottom coil 210 of a second subcoil 200 are soldered to form a layer, and a top coil 220 of the second subcoil 200 and a top coil 320 of a third subcoil 300 are soldered to form a layer), i.e., four coils. By adopting the method for manufacturing a multi-layer coil of the present disclosure, three double-layer single-turn subcoils can form a six-layer single-turn coil structure, i.e., six coils. It can be seen that more coils are included in the formed multi-layer coil structure by consuming the same number of subcoils, and under the same size, the sum of the number of turns of the multi-layer single-turn structure exceeds that of traditional coils, thereby manufacturing products with a larger performance range.

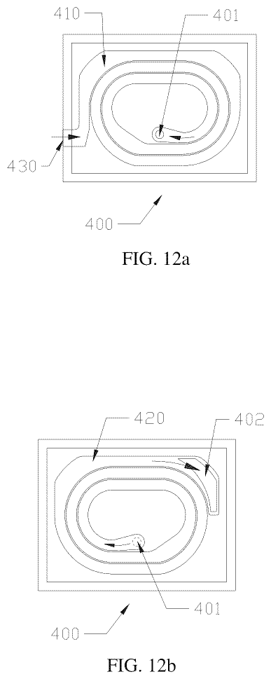

Referring to FIG. 12a to FIG. 14b, the multi-layer coil structure of the present disclosure will be described below by taking each subcoil being double-layer multi-turn as an example.

In FIG. 12a and FIG. 12b, a structure of a first subcoil 400 is shown, FIG. 12a is a top view from the bottom coil 410 direction, and FIG. 12b is a top view from the top coil 420 direction. A head end of a bottom coil 410 of the first subcoil 400 is a first electrode end 430, and a through hole is formed in an insulating film corresponding to a tail end of the bottom coil 410 and is provided with a first contact 401. A current flows from the first electrode end 430 to the tail end of the bottom coil 410 of the first subcoil 400, then flows to a head end of a top coil 420 of the first subcoil 400 via the first contact 401, and finally is led out from a conductive material arranged in a first via hole 402 in a tail end of the top coil 420.

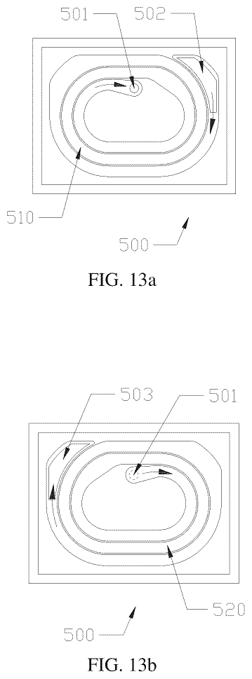

In FIG. 13a and FIG. 13b, a structure of a second subcoil 500 is shown, FIG. 13a is a top view from the bottom coil 510 direction, and FIG. 13b is a top view from the top coil 520 direction. A second via hole 502 is formed in an insulating layer corresponding to a head end of a bottom coil 510 of the second subcoil 500, and the second via hole 502 is aligned with the first via hole 402.

The head end of the bottom coil 510 is in communication with the tail end of the top coil 420 via the conductive material arranged in the first via hole 402, and a current flows from the conductive material in the first via hole 402 to the head end of the bottom coil 510, then to a tail end of the bottom coil 510, is conducted to a head end of a top coil 520 of the second subcoil 500 via a second contact 501 arranged at the tail end of the bottom coil 510, and finally is led out from a conductive material arranged in a third via hole 503 in a tail end of the top coil 520.

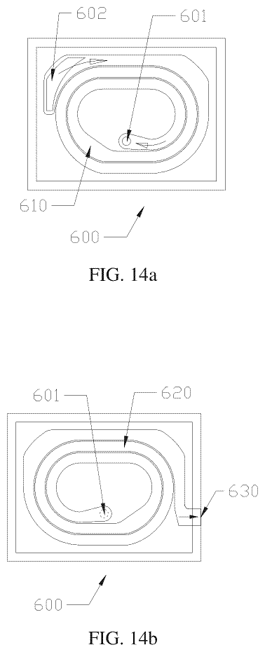

In FIG. 14a and FIG. 14b, a structure of a third subcoil 600 is shown, FIG. 14a is a top view from the bottom coil 610 direction, and FIG. 14b is a top view from the top coil 620 direction. A fourth via hole 602 is formed in an insulating layer corresponding to a head end of a bottom coil 610 of the third subcoil 600, and the fourth via hole 602 is aligned with the third via hole 503.

The head end of the bottom coil 610 of the third subcoil 600 is in communication with the tail end of the top coil 520 of the second subcoil 500 via the conductive material arranged in the third via hole 503, and a current flows from the conductive material in the third via hole 503 to the head end of the bottom coil 610, then to a tail end of the bottom coil 610, is conducted to a head end of a top coil 620 of the third subcoil 600 via a third contact 601 arranged at the tail end of the bottom coil 610, and finally flows out from a tail end, i.e., a second electrode end 630, of the top coil 620.

It can be understood that the second subcoil 500 may be several in number and is not limited to one in the examples, and can be designed on its own as required. According to the multi-layer multi-turn coil structure of the present disclosure, each double-sided subcoil is subjected to insulation processing, thereby not only solving the problem of insulation between coil gaps, but also forming more layers in products in the same volume, i.e., obtaining more turns.

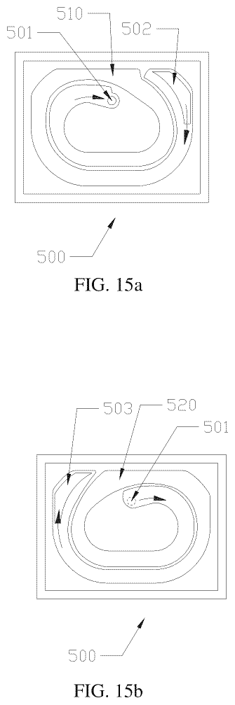

In the above example where the multi-layer multi-turn coil structure is formed by each subcoil being of a double-layer multi-turn structure, each subcoil shown has the same number of turns (three turns). In practical applications, the number of turns of the bottom coil and the top coil of each subcoil can be designed on its own as required, for example, the second subcoil 500 with three turns of the top coil and three turns of the bottom coil is designed as a structure with two turns of the top coil and two turns of the bottom coil, as shown in FIG. 15a and FIG. 15b, FIG. 15a is a top view from the bottom coil direction, and FIG. 15b is a top view from the top coil direction; it only needs to be met that adjacent via holes are aligned with each other after subcoils are stacked. Thus, the multi-layer coil structure produced by the present disclosure can be combined on its own initiative to generate several structures with different inductance values, and has a wide range of application; and compensates the disadvantages of insufficient saturation and excessive DCR when designing specific inductance-value products in traditional multi-layer single-turn and double-layer multi-turn.

The above description shows and describes the preferred embodiments of the present disclosure, and it should be understood that the present disclosure is not limited to the forms disclosed herein, and should not be considered as excluding other embodiments, but can be used in various other combinations, modifications and environments, and can be changed within the scope of the inventive concept of the present disclosure by means of the above teaching or technologies or knowledge in related fields. Any modification or alteration made by those skilled in the art without departing from the spirit and scope of the present disclosure shall fall within the scope of protection of the appended claims of the present disclosure.

1. A multi-layer coil structure, comprising:
at least two subcoils arranged in a stacked manner, wherein each of the at least two subcoils comprises a bottom coil, an insulating film arranged on the bottom coil, and a top coil arranged on the insulating film, the insulating film comprises at least one through hole, a contact is arranged in the at least one through hole so that the bottom coil and the top coil located on two sides of the insulating film are in electrical contact with each other, outer surfaces of the bottom coil and the top coil are both provided with an insulating layer, and the insulating layer is provided with a via hole;
via holes in adjacent subcoils of the at least two subcoils are aligned with each other, and metal contacts are arranged in the via holes so that the adjacent subcoils are in electrical contact with each other; and
the at least one through hole and the via hole in a same subcoil are arranged in a staggered manner.

2. The multi-layer coil structure according to claim 1, wherein a total width of each of the at least two subcoils is equal.

3. The multi-layer coil structure according to claim 1, wherein the via hole in a subcoil of the at least two subcoils located at a bottom layer corresponds to a tail end of a top coil of the subcoil located at the bottom layer, a via hole in a subcoil of the at least two subcoils located at a top layer corresponds to a head end of a bottom coil of the subcoil located at the top layer, and via holes in subcoils of the at least two subcoils located in a middle between the bottom layer and the top layer correspond to head ends of bottom coils of the subcoils in the middle and tail ends of top coils of the subcoils in the middle, respectively.

4. An inductor, comprising the multi-layer coil structure according to claim 1 and a magnet cladding the multi-layer coil structure.

5. The inductor according to claim 4, wherein a total width of each of the at least two subcoils is equal.

6. The inductor according to claim 4, wherein a via hole in a subcoil of the at least two subcoils located at a bottom layer corresponds to a tail end of a top coil of the subcoil located at the bottom layer, a via hole in a subcoil of the at least two subcoils located at a top layer corresponds to a head end of a bottom coil of the subcoil located at the top layer, and via holes in subcoils of the at least two subcoils located in a middle between the bottom layer and the top layer correspond to head ends of bottom coils of the subcoils in the middle and tail ends of top coils of the subcoils in the middle, respectively.

7. A method for manufacturing a multi-layer coil structure, comprising the following steps:
S1, preparing at least two full-board double-sided coils, each of the at least two full-board double-sided coils comprising two or more subcoils arranged in an array, and each of the two or more subcoils being a double-sided coil;
S2, subjecting each of the at least two full-board double-sided coils to insulation processing, so that an outer surface of each of the double-sided coils is coated with an insulating layer;
S3, forming via holes for coils to be in communication with outside by removing an insulating layer corresponding to a head end of each bottom coil of a full-board double-sided coil of the at least two full-board double-sided coils located at a top layer, removing an insulating layer corresponding to a tail end of each top coil of a full-board double-sided coil of the at least two full-board double-sided coils located at a bottom layer, and removing insulating layers corresponding to head ends of bottom coils and tail ends of top coils of full-board double-sided coils of the at least two full-board double-sided coils located in a middle between the bottom layer and the top layer;
S4, filling via holes in top coils with a conductive material, a height of the conductive material being greater than twice a height of a peripheral insulating layer of the top coils;
S5, stacking and attaching two or more full-board double-sided coils of the at least two full-board double-sided coils subjected to processing in the S2, the S3 and the S4, and aligning via holes in two adjacent full-board double-sided coils of the at least two full-board double-sided coils on a one-to-one basis;
S6, heating, so that insulating layers of the adjacent full-board double-sided coils are adhered and fixed; and
S7, cutting to obtain single coils formed by stacking the two or more subcoils.

8. The method for manufacturing a multi-layer coil structure according to claim 7, wherein a method for preparing the at least two full-board double-sided coils in the S1 comprises:
laying a first conductive metal;
etching the first conductive metal to form two or more bottom coil patterns;
laying an insulating film on the first conductive metal, the insulating film being provided with a through hole;
arranging a contact in the through hole, an upper end surface of the contact protruding from an upper surface of the insulating film;
laying a second conductive metal on the insulating film; and
etching the second conductive metal to form two or more top coil patterns, top coils of the top coil patterns being in contact with the contact.

9. The method for manufacturing a multi-layer coil structure according to claim 8, wherein a method for subjecting each of the at least two full-board double-sided coils to the insulation processing in the S2 comprises: vacuum-plating the each of the at least two full-board double-sided coils so that the outer surface of each of the at least two full-board double-sided coils is coated with the insulating layer, the insulating layer being made of Parylene or silicon dioxide.

10. The method for manufacturing a multi-layer coil structure according to claim 8, wherein a method for subjecting each of the at least two full-board double-sided coils to the insulation processing in the S2 comprises: coating the outer surface of each of the at least two full-board double-sided coils with the insulating layer by using a dispensing process or using a printing process, the insulating layer being made of epoxy resin or an ultraviolet (UV) curing adhesive.

11. The method for manufacturing a multi-layer coil structure according to claim 7, wherein in the S2, after subjecting each of the at least two full-board double-sided coils to the insulation processing and before forming the via holes in the S3, the method further comprises recognizing each of the at least two full-board double-sided coils to detect whether the outer surface of each of the at least two full-board double-sided coils is completely covered with the insulating layer.
